(19) United States
(12) Patent Application Publication
(10) Pub. No.: US 2013/0027206 A1
(43) Pub. Date: Jan. 31, 2013

(54) Portable Medicament Compliance Administrator System

(71) Applicant: Dale H. Kosted, Enid, OK (US)

(72) Inventor: Dale H. Kosted, Enid, OK (US)

(21) Appl. No.: 13/557,020

(22) Filed: Jul. 24, 2012

Related U.S. Application Data
(60) Provisional application No. 61/572,922, filed on Jul. 25, 2011.

(51) Int. Cl. G08B 23/00

(52) U.S. Cl. 340/573.1

(57) ABSTRACT

A system for annunciating and tracking dispensing of at least one medicament according to a predetermined schedule. The system comprises a small, portable device functional to issue reminder signals when it is appropriate to administer a medicament and to record medicament dispensing events. The system includes a master data processor such as a personal computer which is functional to download operating instructions to the portable device and to retrieve data pertaining to recorded events. The portable device may cooperate with an electronic card or key which may be used to enter identification data pertaining to medicaments to the portable device, and to reset the portable device to continue to operate according to originally downloaded operating instructions. The receptacle which stores the medicament may be controlled to dispense only a limited dosage of the medicament.

### REFERENCE TO RELATED APPLICATION

This application claims priority to Provisional Patent Application Ser. No. 61/572,922, filed Jul. 25, 2011.

### FIELD OF THE INVENTION

The present invention relates to a system for monitoring, facilitating, and reporting compliance of a medical patient with a medicament regimen.

### BACKGROUND OF THE INVENTION

Prescription of medicaments for human and non-human patients has been susceptible to diverse sources of disruption which threaten or destroy efficacy of the prescribed regimen. Firstly, the user must frequently be reminded to take the prescribed medicaments. Also, reminders may have to track plural medicaments which may be taken on different schedules. Once a medicament has been taken, medical personnel such as those issuing the prescription may need to be advised of compliance with the prescribed regimen. That is, it may become desirable to establish a permanent or readable record of which medicaments were taken by the patient and when. Responsibility for making such a record has traditionally fallen on the patient or his family, and may comprise an informal written record, such as marking a calendar, making entries in a diary, entering data into a personal computer, smart phone, or other data handling device, or merely relying on human memory. These traditional forms of establishing a permanent or readable have proved notoriously unreliable.

Electronic and data handling reminders and other devices for administering medicament regimens have been proposed, but have fallen short of providing all of the features that substantially assure proper administration of medicaments and accurate records of the same. There remains a need for an administrative system which will overcome the deficiencies of the prior art.

### SUMMARY OF THE INVENTION

The present invention addresses the above stated need by providing a system which is based on data processing, and which includes a portable data handling advisory and data collecting component, or portable communicator, which is programmable to issue an advisory to take a medicament, and is functional to record dispensing of medicaments. The portable data handling advisory and data collecting component may comprise a relatively small platform which supports electronic functions and provides annunciators for reminding the user that it is time to take a medicament. This component may be realized as a pendant for a necklace, part of a bracelet or other body worn jewelry and devices, as a tag which is attachable to the collar of a pet for non-human uses, and may incorporate a magnet or clip for attachment to a suitable environmental surface such as a metal refrigerator or other household, vehicular, or other environmental surface. In one realization of the invention, the portable communicator may be integrated into the cap of a standard medicine or pill bottle. Where this is practiced, the cap or other closure or housing component of the bottle or other medicament receptacle may be arranged not merely open to finger access to the interior, but rather to limit dispensing to one pill or other medicament object. This feature overcomes casual misuse of the medicament, such as withdrawing several pills or medicaments when only one is to be used.

The portable communicator works with other parts of a larger system. Notably, it may be placed in data transfer relation to a master data processor such as a personal computer. Data such as identification of which specific medicaments are to be used and the schedule for annunciating when it is time to take any one of the medicaments may be downloaded into the portable communicator. The portable communicator may incorporate sensors which record when dispensing of a medicament occurs, which data may then be uploaded to the personal computer. To this end, the portable communicator may comprise a data connector such as a miniaturized USB or the like in addition to microprocessor, battery, external indicator lights, and optional external pushbuttons.

In one realization of the invention, some functions may be initiated by use of an insertable data device which is read by the portable communicator. The insertable data device may comprise an electronic card having machine readable indicia or which may issue corresponding data in electronic form, so that once inserted into the portable communicator, the latter records a dispensing event for the record. The electronic card is particular useful to reset the portable communicator to enable a subsequent cycle of dispensing and recording of data after an initial cycle has been completed. This option enables a user to reset the programming of the portable communicator without imposing the necessity of returning to the prescriber for connection to a personal computer for what may be merely a routine continuation of a medicament regimen. In this way, substantial control of the portable communicator remains with the prescriber. Intentional and unintentional misuse of the portable communicator is overcome.

The system may also comprise software which enables medical personnel to program the portable communicator to perform as is appropriate for any appropriate medicament regimen, and to record and display usage data from downloaded data.

It is one object of the invention to provide a system having readily portable monitoring and recording of dispensing of medicaments.

Another object of the invention is to establish an electronic record of dispensing events and to facilitate transfer of recorded data to external data processing devices.

A further object of the invention is to leave day-to-day control in the hands of the user, while reserving elements of control for qualified medical personnel.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of exemplary components of a system according to at least one aspect of the invention.

FIG. 2 is a diagrammatic representation of components which are internal to a component seen at the center of FIG. 1.

FIG. 3 is a perspective view of an optional implementation of the invention wherein the component seen at the center of FIG. 1 is integrated into a receptacle for medicaments.

FIG. 4 is an environmental front view of an optional form of a component seen at the center right of FIG. 1.

FIG. 5 is an environmental front view of a further optional form of the component seen at the center right of FIG. 1.

FIG. 6 is a side view of still another optional form of the component seen at the center right of FIG. 1.

FIG. 7 is a side view of a further optional form of the component seen at the center right of FIG. 1.

FIG. 8 is an environmental side view of still another optional form of the component seen at the center right of FIG. 1.

FIG. 9 is a side view of another optional implementation of the invention wherein the component seen at the center of FIG. 1 is integrated into a receptacle for medicaments.

### DETAILED DESCRIPTION

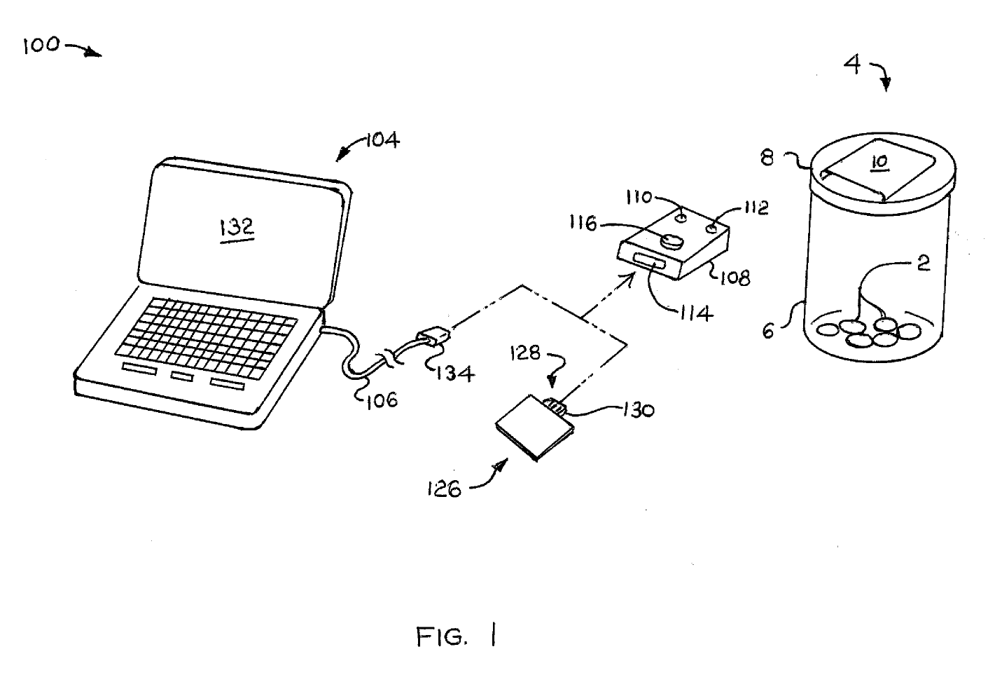

FIG. 1 shows essential components of a system according to at least one aspect of the invention, and promotes conceptual understanding of the novel system. The novel system established by the components of FIG. 1 are for administering medicament dispensing events and establishing an electronic record of medicament dispensing events. It is contemplated that medicaments are in the possession of a patient or user (not shown), and may include for example medicine pills 2 which are stored in and are to be dispensed from a receptacle such as a standard pill bottle 4. The pill bottle 4 may comprise a receptacle portion 6 and a removable cap 8.

The novel system 100 may comprise a portable communicator 102 and a separate master data processor, seen here as a personal computer 104. The portable communicator 102 has data processing capabilities and therefore may communicate or interface with the personal computer 104 by a suitable data transmission device such as a USB cable 106. The portable communicator 102 comprises a housing 108, bearing externally mounted annunciators, such as LED indicating lights 110, 112, and a data connector which in the present example is a USB compatible port 114. The USB compatible port 114 is accessible from the exterior of the housing 108, and hence will be regarded as being externally mounted thereon. An optional pushbutton 116 may also be disposed on the exterior of the housing 108. The indicating lights 110, 112 are functional to annunciate at least one condition pertaining to a dispensing event, as will be further described hereinafter.

FIG. 2 diagrammatically shows internal components of the housing 108. These internal components may include a microprocessor 118, a battery 120, and a sensor 122 which is functional to record a dispensing event. The internal and external electrically powered components are of course interconnected by a data transmitting control circuit and by a power circuit. Circuitry is indicated collectively as power and signal conductors 124. As employed herein, circuitry will be understood to include all necessary conductors, switches, and other supporting devices which may not be shown to enable operation to proceed as described.

Also referring again to FIG. 1, the sensor 122 is functional to infer or sense removal of the cap 8 or to sense another operational aspect of the pill bottle 4 which would be indicative of a medicament such as the pill 2 being dispensed from the pill bottle 4. One way of operating the sensor 122 is to provide an electronic card 126 which may comprise a projection 128 bearing readable indicia, such as a barcode 130, magnetic encoding, or other forms of machine readable communication. The electronic card 126 may be but is not necessarily disposed to communicably connect to the USB compatible port 114 of the portable communicator 102, and is functional to provide data to the microprocessor 118 of the portable communicator, for identifying a medicament to be dispensed and to initiate a step of establishing the record of medicament dispensing events, as well as to signal that the medicament is actually being dispensed. When the sensor 122 senses or infers that a pill 2 is being withdrawn or dispensed, a record of that is entered into the memory of the microprocessor 118. It should be emphasized at this point that the electronic card 126 bearing the barcode 130 or other comparable form of indicia is specific to the medicament to be dispensed at any one time.

It should be noted that over a time interval, plural medicaments may be dispensed and administered by the user. The microprocessor 118 is functional to record all of these dispensing events, and to maintain a date log and even time of day log of these events.

The electronic card 126 may be associated with the pill bottle 4, for example being stored within a pocket 10 formed in the cap 8. The projection 128 may be compatible with and readable by the USB compatible port 114. In this situation, the electronic card 126 is made readily available to a person using the pill bottle 4 when a pill 2 is dispensed.

As an alternative to the sensor 122 causing electronic data transfer to the microprocessor, the sensor 122 may comprise a barcode reader mounted such that it reads the barcode 130 when the projection 128 is inserted into the USB compatible port 114, and generates a data signal responsively.

It may be said here that whereas connection of a data terminal such as the data terminal 134 of the cable 106 may initiate data transfer without further affirmative action by the user, a different scheme may be appropriate for barcode reading. To this end, the pushbutton 116 may initiate barcode reading, and may be deployed when the projection 128 is inserted into the USB compatible port 114 or into a separate barcode reader (not shown), where the barcode reader is not associated with the USB compatible port 114.

The personal computer 104 is functional to download operating instructional data to the microprocessor 118 and to retrieve data corresponding to recorded dispensing events from the microprocessor 118. It should be noted that the microprocessor 118 is functional to retrieve data from the electronic card 126 which corresponds to identification of a particular medicament which is associated with the electronic card 126, and to compare identification of the medicament with identification of a medicament which is scheduled to be dispensed according to downloaded operating instructional data. Errors in dispensing, such as dispensing of the wrong medicament when a medicament regimen includes plural medicaments can thus be brought to the attention of the system 100. Of course, proper use of the electronic card 126 is likely to prevent such occurrences.

Retrieved data may then be displayed on the screen 132 of the personal computer 104. The personal computer 104 may be detachably placeable in communication with the portable communicator 102 by interfacing with the USB compatible port 114 using the USB cable 106 to transfer data between the personal computer 104 and the data connector 114 and ultimately, the microprocessor 118 of the portable communicator 102.

Annunciation may work according to the following scheme. The LED indicating light 110 may be a reminder annunciator disposed to annunciate when it is time to dispense a medicament by issuing a perceptible signal, such as by illuminating. The LED indicating light 112 may be a confirming annunciator disposed to confirm that the electronic card 126 has identified or confirmed that a medicament actually to be dispensed is in accord with downloaded operational instructional data downloaded to the microprocessor 118 by issuing a perceptible signal, such as by illuminating.

It would be possible to operate an annunciator such as the LED indicating light 110 in a fault mode wherein a perceptible signal is issued to signal a system failure, which perceptible signal is different from the perceptible signal which annunciates when it is time to dispense a medicament. The signal indicating a system failure could be for example, detection of a mismatch between the medicament which is intended to be dispensed and administered and the sensed identification of a different and presumably erroneous medicament.

One implication of the use of a separate portable communicator 102 and personal computer 104 is that the functions of the portable communicator 102 may be implemented or controlled solely by instructions downloaded from the personal computer 104, and hence are ultimately controllable only by the master data processor, which preferably remains in the possession of the medical personnel establishing the medicament regimen. A sole exception is that a reset function which controls the portable communicator 102 to operate the reminder annunciator to continue to operate according to the same downloaded operational instructional data may be performed by a person in possession of the portable communicator, and does not rely on the medical personnel. In one implementation of the invention, the reset function may be automatically initiated by placing the inserting electronic card 126 into the USB compatible port 114 such that the projection 128 and hence the indicia, such as the barcode 130, is in communicable connection relative to the USB compatible port 114.

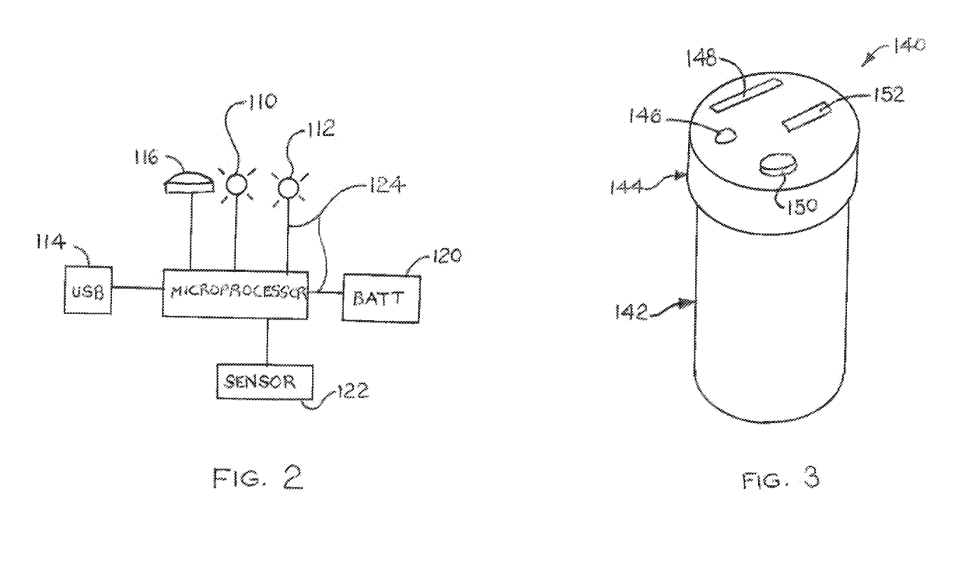

FIG. 3 shows an implementation of the invention wherein the components of a system otherwise similar to the system 100 are integrated into a medicament storing and dispensing receptacle 140. More particularly, in the example of FIG. 3, components of a portable communicator such as the portable communicator 102 are integrated into the closure of the medicament storing and dispensing receptacle 140, such as the cap 144. The medicament storing and dispensing receptacle 140 may comprise a receptacle portion 142 and the cap 144. All of the functional components of the portable communicator 102 may be integrated into the cap 144 or alternatively, into the receptacle portion 142 of the medicament storing and dispensing receptacle 140. As depicted in FIG. 3, an annunciator in the form of an LED indicating light 146, an audible annunciator in the form of a miniature speaker 148, a pushbutton 150, and a USB compatible port 152 are integrated with the cap 144. The pushbutton 150 may both release the cap 144 to disengage from the receptacle portion 142 and may also generate a signal indicative of dispensing. Such a signal would be entered into the memory of the microprocessor (not shown) which could be embedded in the cap 144 for subsequent reporting to a master data processor such as the personal computer 104. The USB compatible port 152 would serve the same function as that used in the system 100. The annunciators provided by the LED indicating light 146 and miniature speaker 148 could be used to annunciate when it is time to take a medicament, or to annunciate an alarm condition, such as depletion of the medication or failure to reinstall the cap 144 after a predetermined time interval for example.

With the basic components of the system 100 now described, a theoretical operating scenario for the system 100 will be described. A hypothetical patient is admitted to a hospital, and is prescribed three medications. The first medication is an antibiotic with schedule QID, length fourteen days. The second medication is an anti-inflammatory with schedule BID, length ten days. The third medication is a diuretic, schedule SID, length five days.

Three portable communicators 102 are programmed to indicate dispensing of respective medications at appropriate times. The medications may be provided in separate, color coded containers which may correspond to color coding of the three portable communicators 102. Each container may have an electronic card such as the electronic card 126.

When the time arrives to administer one of the medications, an annunciator such as the LED indicating light 110 of the appropriate portable communicator 102 would illuminate, and could illuminate intermittently or flash, for example. A nurse would administer the medication and insert the electronic card 126 associated with the dispensed medication into the portable communicator color coded to the dispensed medication. This would reset a time counting feature of the microprocessor 118 of the appropriate portable communicator 102, so that the subsequent medication time for that medication will be annunciated at the appropriate time in the future. Because the microprocessor 118 has had the total number of medication dispensings downloaded as part of the operating instructions, it will signal completion of the medication regimen for each medication as each such medication regimen expires. More specifically, an annunciator such as one of the LED indicating lights 110 or 112 may illuminate.

The LED indicating lights 110, 112 may assume plural functions which may be discerned by the user in various ways. For example, steady illumination of an LED indicating light 110 or 112 may signal one message, whereas intermittent illumination or flashing may signal another message. Also, simultaneous illumination of plural LED indicating lamps 110, 112 may be utilized to signal still another message.

Regardless of which type of signal is selected, the annunciators may be operated to signal completion of the medication regimen for a medication, depletion of the supply of medicaments, where data corresponding to the supply had been entered into the microprocessor 118 as part of the initial operating instructions.

In this hypothetical example, the patient may leave the hospital before completion of all medication regimens. The patient would keep in his or her possession the portable communicators 102 for those uncompleted medications. Relying upon color coding, the patient could than take the appropriate medication when prompted to do so by an annunciator. These portable communicators 102 could be retained and brought to follow-up visits to medical personnel. The medical personnel could then download data from the portable communicators 102 and display or otherwise review the record of compliance with the medication regimens. Compliance may thus be achieved without relying upon the memory or accuracy of the patient. For his or her part, because of color coding, the patient may take the prescribed medications responsive to prompts issued by the annunciators, again not relying upon memory or other knowledge relating to the medications. This is especially desirable in the case of geriatric patients.

With basic operation of the inventive concept now described, some variations will be presented. Referring to FIG. 4, a portable communicator 160 which in other ways may be structurally and functionally similar to the portable communicator 102 is configured as a pendant device 162 including the portable communicator 160 and a clasp 164, which may be fastened to an item of body worn jewelry such as a necklace 12.

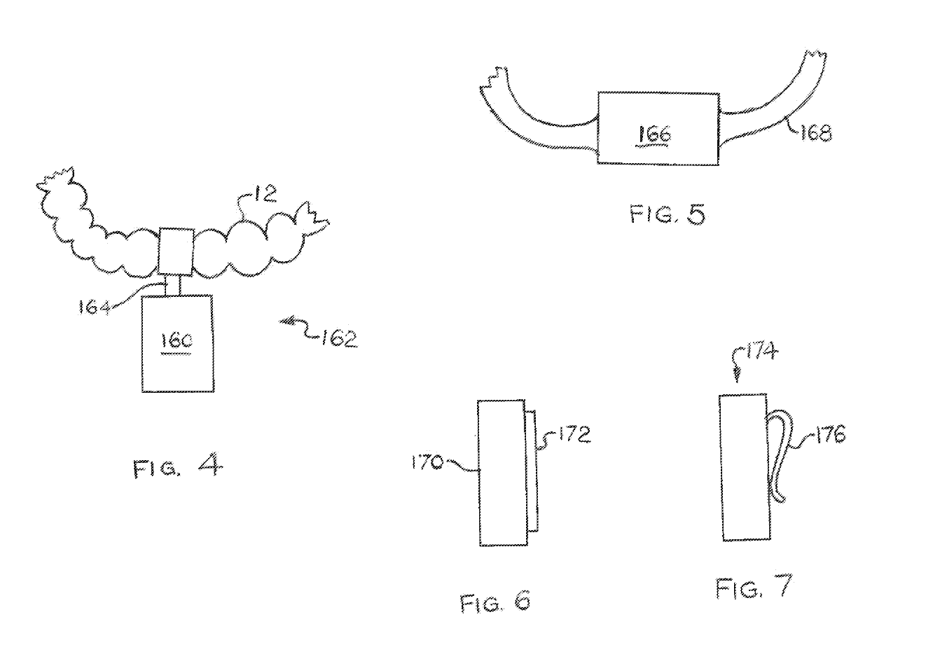

In FIG. 5, a portable communicator 166 which in other ways may be structurally and functionally similar to the portable communicator 102 may be integrated as a permanent part of body worn jewelry, such as a bracelet 168.

In FIG. 6, a portable communicator 170 which in other ways may be structurally and functionally similar to the portable communicator 102 may comprise an attachment element enabling manually removable attachment of the portable communicator 170 to an environmental object. In FIG. 6, the attachment element may comprise a magnet 172. Suitable shielding (not shown) may be provided to protect electronic components of the portable communicator 170 from disruption by the magnet 172. In FIG. 7, a portable communicator 174 which in other ways may be structurally and functionally similar to the portable communicator 102 may be provided with an attachment element such as a clip 176.

FIG. 8 shows an arrangement wherein a portable communicator 178 which in other ways may be structurally and functionally similar to the portable communicator 102 comprises a tag which is attachable to a body encircling device. In other implementations, it has been assumed that the invention is intended for human use. However, the invention is not so limited, and may be used for pets, livestock, and other animals. Hence, the body encircling device may be a pet collar 14 for a pet such as a dog 16. A suitable connector such as a loop 180, a snap ring, or other connector may be provided for removable attachment of the portable communicator 178 to the pet collar 14.

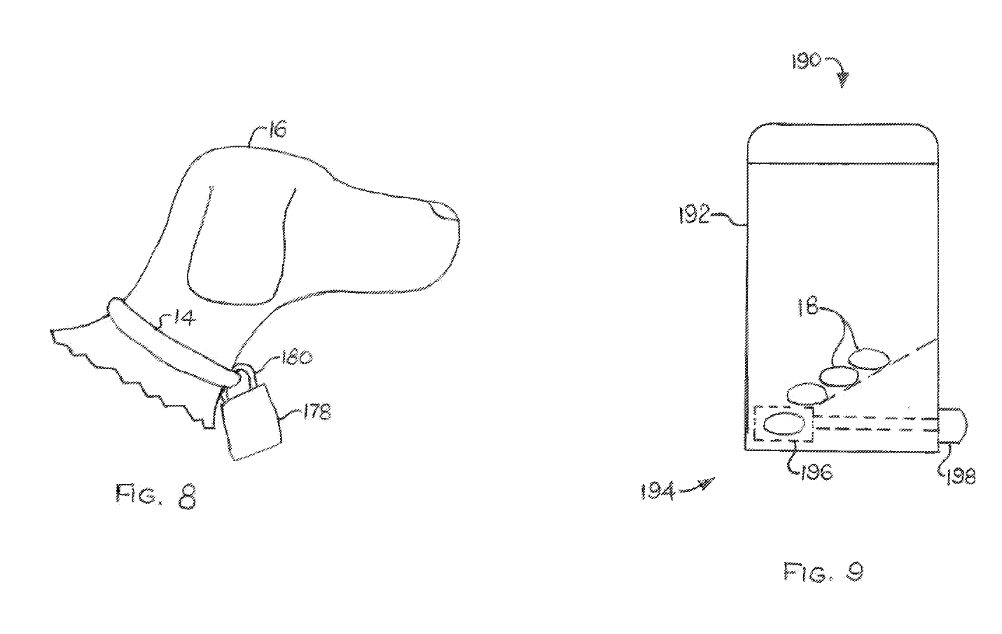

Referring now to FIG. 9, a medicament storing and dispensing receptacle 190 may comprise a receptacle portion 192 for receiving and storing medicaments such as pills 18 for subsequent dispensing, and a dispenser 194 which is disposed to dispense a controlled dosage of stored medicaments such as the pills 18. The dispenser 194 may be similar to known arrangements which eject one pill, lozenge, or other object from a large supply of such pills, lozenges, or other objects when actuated, and may include a cradle 196 which holds only one pill 18. The cradle 196 may be deployed to dispense one pill 18 by a pushbutton 198. Such arrangements are known in candy dispensers for example. The purpose of such a feature is to discourage excessive dispensing in any one dispensing operation. For example, a pill 18 which has been flavored or sweetened to promote acceptance by pediatric patients may encourage the patient to take more pills 18 than should be taken at any one time.

The medicament storing and dispensing receptacle 190 may comprise a portable communicator 200 which is the functional equivalent of the portable communicator 102, attached to or integrated with the receptacle portion 192. The portable communicator 200 may be connected to the pushbutton 198 to sense operation thereof, with a record of operation events being entered into the memory of the portable communicator 102. Knowledge that each operation of the dispenser 194 is being recorded may dissuade casual unauthorized dispensing.

The invention is subject to variations and modifications which may be introduced thereto without departing from the inventive concept. For example, the arrangement using the USB cable 106 could be replaced or supplemented by a wireless arrangement (not shown) if desired.

It would also be possible to administer plural medicaments using one portable communicator (not shown) which is similar in function to the portable communicator 102, but is adapted for the plural medicaments. While this option is possible, it is presently not preferred due to issues with possible confusion as to which medicament is to be dispensed when an annunciator signals that a medicament is to be administered.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. A system for administering medicament dispensing events and establishing an electronic record of medicament dispensing events, comprising:
a portable communicator comprising a housing, a microprocessor enclosed within the housing, a battery enclosed within the housing, a sensor enclosed within the housing which is functional to record a dispensing event, at least one annunciator mounted externally on the housing to annunciate at least one condition pertaining to a dispensing event, a data connector, a control circuit disposed to operate and interconnect the microprocessor, the sensor, the annunciator, and the data connector, and a power circuit disposed to connect power from the battery to the microprocessor, the sensor, and the annunciator; and
a master data processor which is functional to download operating instructional data to the microprocessor and to retrieve data corresponding to recorded dispensing events from the microprocessor, and to be detachably placeable in communication with the portable communicator by interfacing with the data connector of the portable communicator.

2. The system of claim 1, further comprising an electronic card which is disposed to communicably connect to the data connector of the portable communicator, and is functional to provide data to the microprocessor of the portable communicator, for identifying a medicament to be dispensed and to initiate a step of establishing the record of medicament dispensing events.

3. The system of claim 1, wherein the portable communicator is configured as a pendant device for body worn jewelry.

4. The system of claim 1, wherein the portable communicator is integrated into body worn jewelry.

5. The system of claim 1, wherein the portable communicator comprises an attachment element enabling manually removable attachment of the portable communicator to an environmental object.

6. The system of claim 1, wherein the portable communicator comprises a tag which is attachable to a body encircling device.

7. The system of claim 6, wherein the body encircling device is a pet collar.

8. The system of claim 1, further comprising a medicament storing and dispensing receptacle, and wherein the portable communicator is integrated into the medicament storing and dispensing receptacle.

9. The system of claim 8, wherein the medicament storing and dispensing receptacle comprises a closure, and the portable communicator is integrated into the closure.

10. The system of claim 1, wherein the master data processor comprises a personal computer.

11. The system of claim 10, further comprising a data cable which is disposed to be in data transfer relation to the personal computer and to the data connector of the portable communicator.

12. The system of claim 11, wherein the data connector of the portable communicator comprises a USB compatible port.

13. The system of claim 1, wherein the annunciator comprises a reminder annunciator disposed to annunciate when it is time to dispense a medicament by issuing a perceptible signal.

14. The system of claim 2, wherein the microprocessor of the portable communicator is functional to retrieve data from the electronic card which corresponds to identification of a medicament which is associated with the electronic card and to compare identification of the medicament with identification of a medicament which is scheduled to be dispensed according to downloaded operating instructional data.

15. The system of claim 14, wherein the annunciator comprises a confirming annunciator disposed to confirm that the electronic card identifying a medicament to be dispensed has identified a medicament which is actually to be dispensed is in accord with downloaded operational instructional data downloaded to the microprocessor of the portable communicator by issuing a perceptible signal.

16. The system of claim 1, wherein the functions of the portable communicator are controllable only by data downloaded from the master data processor, with the sole exception that a reset function which controls the portable communicator to operate the reminder annunciator to continue to operate according to the same downloaded operational instructional data may be performed by a person in possession of the portable communicator.

17. The system of claim 2, wherein
the functions of the portable communicator are controlled only by data downloaded from the master data processor, with the sole exception that a reset function which controls the portable communicator to operate the reminder annunciator to continue to operate according to the same downloaded operational instructional data may be performed by a person in possession of the portable communicator, and wherein
the reset function is automatically initiated by placing the electronic card in communicable connection to the data connector of the portable communicator.

18. The system of claim 13, wherein the reminder annunciator may be operated in a fault mode wherein a perceptible signal different from the perceptible signal which annunciates when it is time to dispense a medicament.

19. The system of claim 2, further comprising a medicament storing and dispensing receptacle, and wherein the electronic card is stored in association with the medicament storing and dispensing receptacle and thus is made available to a person using the medicament storing and dispensing receptacle when a medicament is dispensed from the medicament storing and dispensing receptacle.

20. A medicament storing and dispensing receptacle comprising
a receptacle portion for receiving and storing medicaments for subsequent dispensing;
a dispenser disposed to dispense a controlled dosage of stored medicaments; and
a data recording system disposed to record dispensing events performed using the dispenser and to transmit data pertaining to recorded dispensing events, comprising a sensor which is functional to sense a dispensing event and to generate a signal indicative thereof, and a memory functional to receive and store the signal, and to transfer data pertaining to the signal to an external data processing device.
